(19) United States
(12) Patent Application Publication
(10) Pub. No.: US 2025/0035595 A1
(43) Pub. Date: Jan. 30, 2025

(54) SYSTEMS AND METHODS FOR ACOUSTIC ANALYSIS OF SEI FORMATION IN BATTERIES

(71) Applicant: Liminal Insights, Inc., Emeryville, CA (US)

(72) Inventors: Austin Ryan DULANEY, Castro Valley, CA (US); Shaurjo BISWAS, El Cerrito, CA (US)

(73) Assignee: Liminal Insights, Inc., Emeryville, CA (US)

(21) Appl. No.: 18/784,051

(22) Filed: Jul. 25, 2024

Related U.S. Application Data
(60) Provisional application No. 63/516,259, filed on Jul. 28, 2023.

(51) Int. Cl. G01N 29/44; G01N 29/04

(52) U.S. Cl. CPC G01N 29/4481; G01N 29/04; G01N 2291/025; G01N 2291/106; G01N 2291/2697

(57) ABSTRACT

The present disclosure provides a non-invasive and acoustic signal-based approach for examining a quality of SEI formation for any given battery cell and providing an objective assessment thereof. In one example, the objective assessment may be provided as a score that may be referred to as a Solid Electrolyte Interphase (SEI) score for a given battery cell. In one aspect, a method includes transmitting acoustic signals through a battery cell via one or more first transducers, receiving response signals in response to the acoustic signals at one or more second transducers, determining a score indicative of quality of SEI formation in the battery cell based on analyzing the response signals, and outputting the score.

### CROSS-REFERENCE TO RELATED APPLICATIONS

This application claims the benefit of priority to U.S. provisional application No. 63/516,259, filed on Jul. 28, 2023, entitled “SYSTEMS AND METHODS FOR ACOUSTIC ANALYSIS OF SEI FORMATION IN BATTERIES”, which is expressly incorporated by reference herein in its entirety.

### FIELD OF DISCLOSURE

The present disclosure is directed to systems used for monitoring and inspection of batteries based on acoustic signals. More specifically, exemplary aspects are directed to analysis of data captured upon transmission of acoustic signals through battery cells to determine the quality of Solid Electrolyte Interphase (SEI) formation in the battery cells.

### BACKGROUND

Demand for production of battery cells is on the rise owing to an increase in their use across various industries such as consumer electronics, automotive, clean energy, etc. Efficient and fast battery diagnostics methods are important for increasing quality, lifetime, and manufacturing process efficiency for batteries. In the case of manufacturing and production, reducing costs (e.g., price per kilowatt-hour (kWh)) is an important goal. Production costs and quality can be reduced by optimizing existing processes and/or introducing new technologies. For example, technological advances in the area of improved monitoring, manufacturing, and diagnostics can lead to cost efficiencies by shortening production process times (thus also reducing energy consumption during production), reducing waste due to damaged cells and cell parts, improving quality, etc.

Manufacturing a battery cell involves a series of stages including electrode fabrication/manufacturing (which itself may consist of various sub-stages such as mixing, coating and drying, slitting, calendaring, and vacuum drying), cell assembly (which itself may consist of various sub-stages such as electrode shaping, compound generation, electric contacting, case insertion, case closure, electrolyte filling, and pre-charging), and cell finishing (which may consist of formation and aging). Completion of each stage is critical to ensure long term quality and durability of battery cells for their underlying applications.

### BRIEF DESCRIPTION OF THE DRAWINGS

The accompanying drawings are presented to aid in the description of various aspects of the disclosure and are provided solely for illustration and not limitation.

FIG. 1 illustrates an example system for analyzing a sample using acoustic signal-based analysis according to some aspects of the present disclosure;

FIG. 2 illustrates another example system for analyzing a sample using acoustic signal-based analysis according to some aspects of the present disclosure;

FIG. 3 illustrates an example process flow for determining a quality of SEI formation of a battery cell according to some aspects of the present disclosure;

FIG. 4 is an example illustration of acoustic signals captured during a formation process of a battery cell for purposes of determining an SEI formation score according to some aspects of the present disclosure;

FIG. 5 illustrates an example method of determining an SEI score for a battery cell according to some aspects of the present disclosure;

FIGS. 6A-D illustrate various examples of acoustic signals output as they are processed for determining an SEI formation score for a battery cell according to some aspects of the present disclosure;

FIG. 7 illustrates an example neural network that can be utilized for predicting future performance of battery cells according to some aspects of the present disclosure; and

FIG. 8 illustrates an example architecture of a computing device according to some aspects of the disclosure.

### SUMMARY

The present disclosure provides a non-invasive and acoustic signal-based approach for examining a quality of SEI formation for any given battery cell and providing an objective assessment thereof. In one example, the objective assessment may be provided as a score that may be referred to as an SEI score for a given battery cell.

In one aspect, a method includes transmitting acoustic signals through a battery cell via one or more first transducers, receiving response signals in response to the acoustic signals at one or more second transducers, determining a score indicative of quality of Solid Electrolyte Interphase (SEI) formation in the battery cell based on analyzing the response signals, and outputting the score.

In another aspect, determining the score includes pre-processing the response signals to determine a rate of change of the SEI formation across the battery cell, and determining the score based at least on the rate of change.

In another aspect, pre-processing the response signals includes selecting a subset of the response signals representing acoustic features corresponding to the SEI formation, determining the rate of change in each of the subset of the response signals, and performing an embedding process to determine the score.

In another aspect, the embedding process is one of a principal component analysis or a non-linear embedding process.

In another aspect, the score is determined using a trained machine learning model.

In another aspect, the machine learning model receives, as input, a subset of the response signals representing acoustic features corresponding to the SEI formation, and provides, as output, the score.

In another aspect, the battery cell is going through a manufacturing process when the acoustic signals are transmitted therethrough.

In another aspect, the score is outputted on a graphical user interface.

In another aspect, the score is a weighted average of a plurality of scores, each of the plurality of scores corresponding to a different location on the battery cell through which one of the acoustic signals is transmitted.

In one aspect, a battery inspection system includes a plurality of transducers, and a controller communicatively coupled to the plurality of transducers. The controller is configured to send one or more commands to a first subset of the plurality of transducers for transmitting acoustic signals through a battery cell, receive, from a second subset of the plurality of transducers, response signals in response to the acoustic signals transmitted through the battery cell, and determine a score indicative of quality of Solid Electrolyte Interphase (SEI) formation in the battery cell based on analyzing the response signals, and output the score.

In one aspect, one or more non-transitory computer-readable media include computer-readable instructions, which when executed by one or more processors of a battery inspection system, cause the battery inspection system to send one or more commands to a first subset of a plurality of transducers for transmitting acoustic signals through a battery cell, receive, from a second subset of the plurality of transducers, response signals in response to the acoustic signals transmitted through the battery cell, determine a score indicative of quality of Solid Electrolyte Interphase (SEI) formation in the battery cell based on analyzing the response signals, and output the score.

### DETAILED DESCRIPTION

Certain aspects and embodiments of this disclosure are provided in the following description and related drawings. Alternate aspects may be devised without departing from the scope of the disclosure. Additionally, well-known elements of the disclosure will not be described in detail or will be omitted so as not to obscure the relevant details of the disclosure.

The word “exemplary” is used herein to mean “serving as an example, instance, or illustration.” Any aspect described herein as “exemplary” is not necessarily to be construed as preferred or advantageous over other aspects. Likewise, the term “aspects of the invention” does not require that all aspects of the invention include the discussed feature, advantage or mode of operation.

The terminology used herein is for the purpose of describing particular aspects only and is not intended to be limiting of aspects of the disclosure. As used herein, the singular forms “a,” “an,” and “the” are intended to include the plural forms as well, unless the context clearly indicates otherwise. It will be further understood that the terms “comprises”, “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequences of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As noted above, manufacturing a battery cell involves a series of stages including electrode fabrication/manufacturing (which itself may consist of various sub-stages such as mixing, coating and drying, slitting, calendaring, and vacuum drying), cell assembly (which itself may consist of various sub-stages such as electrode shaping, compound generation, electric contacting, case insertion, case closure, electrolyte filling, and pre-charging), and cell finishing (which may consist of formation and aging). Completion of each stage is critical to ensure long term quality and durability of battery cells for their underlying applications.

Demand for production of battery cells is on the rise owing to an increase in their use across various industries such as consumer electronics, automotive, clean energy, etc. A non-limiting application of battery cells is the electrical vehicle (EV) industry. According to various market research, the industry needs massive buildouts to meeting EV demand by 2030 (around 15 times the current capacity). The cost of battery cell production should decrease by around 40% according to some estimates. Furthermore, as evidence thereof have already been seen, reliability of EV batteries is critical as human and financial remedies of EV recalls due to faulty batteries are immense (already to the tune of more than $3B).

Battery manufacturing processes are not without challenges. For example, the cost of raw materials is on the rise. Issues during manufacturing can lead to poor quality battery cells and hence unreliable battery cell being incorporated into and utilized in their respective applications such as in EVs, which can ultimately lead to the costly failures mentioned above. Also, there is a significant time to obtain information about reliability of the manufacturing process and/or produced battery cells. For example, an error or deficiencies in processes used for electrode fabrication may not be detected until a battery cell is at the formation stage and after having gone through cell assembly, electrolyte filling, etc. Undoing that entire process for thousand to millions of battery cells is very costly.

Furthermore, battery manufacturers may alter one or more aspects or stages of their respective battery manufacturing processes. For instance, a battery manufacturer may, from time to time, test different wetting processes, formation processes, etc. A change in any of these processes may take months of testing and validation, which are also time consuming and costly.

Therefore, efficient and fast battery diagnostics methods are important for increasing quality, lifetime, and manufacturing process efficiencies for batteries. Technological advances in improved monitoring, manufacturing, and diagnostics can lead to cost efficiencies by shortening production process times (thus also reducing energy consumption during production), reducing waste due to damaged cells and cell parts, improving quality, etc.

An example of battery diagnostic solution that addresses the shortcomings of existing solutions (e.g., electrical battery diagnostic solutions) and provide the aforementioned improvements, includes non-invasive and non-destructive analysis of battery cells using acoustic signal-based analysis, whereby acoustic signals are transmitted through one or more battery cells under testing and the received signals are analyzed using various known or to be developed data analytics techniques to assess the physical properties of battery cells and components thereof including state of health, state of charge, battery cell life expectancy, wetting quality, formation quality, aging, etc. Data analytics on signals obtained by ultrasound propagation through materials inside battery cells can be used to analyze electrode slurry parameters including slurry density, trapped air content, viscosity, and uniformity of mixture. In some examples, using the disclosed techniques in battery manufacturing and production can lead to reduction in waste of damaged/scrapped battery cells and shorten production time.

The present disclosure is directed to utilizing acoustic signals and studying information embedded within the acoustic signals to determine a quality of SEI formation on a given battery cell in a fast and efficient manner (e.g., in a matter of seconds).

The example non-invasive and acoustic processes of the present disclosure rely on transmission and reception of acoustic signals through battery cell(s) under testing. The transmission and reception of acoustics signals are enabled using one or more arrays of transducers structured and configured to operate as transmitters and/or receivers of acoustic signals.

The disclosure begins with a description of example systems used for acoustic signal analysis of batteries.

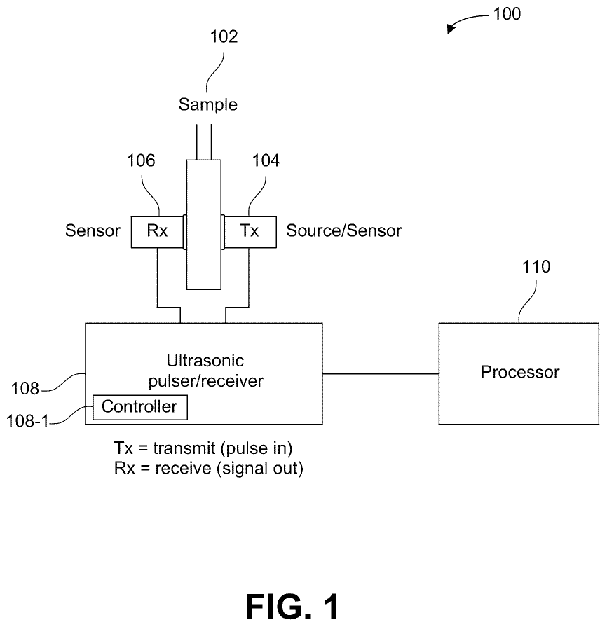

FIG. 1 illustrates an example system for analyzing a sample using acoustic signal-based analysis according to some aspects of the present disclosure. System 100 may include sample 102. Sample 102 can include a battery cell or component thereof in any stage of production or manufacture of the battery cell or the individual components. In some examples, sample 102 can include a battery cell, electrolytes in various stages of wetting/distribution through a battery cell, one or more electrodes of the battery cell, thin films, separators, coated sheets, current collectors, electrode slurries, or materials for forming any of the above components during any stage of their formation. System 100 can include a transmitting transducer (e.g., Tx transducer 104) or other means for sending excitation sound signals into the battery cell (e.g., for transmitting a pulse or pulses of ultrasonic or other acoustic waves, vibrations, resonance measurements, etc., through the battery cell). System 100 can further include a receiving transducer (e.g., Rx transducer 106) or other means for receiving/sensing the sound signals, which can receive response signals generated from signals transmitted by Tx transducer 104. Any type of known or to be developed transducer for transmitting and receiving acoustic signals may be used as Tx transducer 104. Transmitted signals from Tx transducer 104, from one side of sample 102 on which Tx transducer 104 is located, may include input excitation signals. Reflected signals, e.g., from another side of sample 102, may include echo signals. It is understood that references to response signals may include both the input excitation signals and the echo signals. Further, Tx transducer 104 may also be configured to receive response signals, and similarly, Rx transducer 106 may also be configured to transmit acoustic signals. Any type of known or to be developed transducer for transmitting and receiving acoustic signals may be used as Rx transducer 106. Therefore, even though separately illustrated as Tx and Rx, the functionalities of these transducers may be for both sending and receiving acoustic signals. In various alternatives, even if not specifically illustrated, one or more Tx transducers and one or more Rx transducers can be placed on the same side or wall of sample 102, or on different (e.g., opposite) sides. Throughout this disclosure, reference may be made to a transducer pair (a transmitting transducer and a receiving transducer). Tx transducer 104 and Rx transducer 106 may form a pair of transducers.

Acoustic pulser/receiver 108 can be coupled to Tx transducer 104 and Rx transducer 106 for controlling the transmission of acoustic signals (e.g., ultrasound signals) and receiving response signals. Acoustic pulser/receiver 108 may include a controller 108-1 for adjusting the amplitude, frequency, and/or other signal features of the transmitted signals. Acoustic pulser/receiver 108 may also receive the signals from Rx transducers 106. In some examples, acoustic pulser/receiver 108 may be configured as a combined unit, while in some examples, an acoustic pulser for transmitting excitation signals through Tx transducer 104 can be a separate unit in communication with a receiver for receiving signals from Rx transducer 106. Processor 110 in communication with acoustic pulser/receiver 108 may be configured to store and analyze the response signal waveforms according to this disclosure. Although representatively shown as a single processor, processor 110 can include one or more processors, including remote processors, cloud computing infrastructure, etc.

Although not explicitly shown in FIG. 1, more than one Tx transducer and/or more than one Rx transducer can be placed in one or more spatial locations across sample 102. This allows studying a spatial variation of acoustic signal features across sample 102. A multiplexer can be configured in communication with the acoustic pulser/receiver 108 for separating and channeling the excitation signals to be transmitted and the response signals received. In some examples, various acoustic couplants can be used (e.g., solid, liquid, or combinations thereof) for making or enhancing contact between Tx transducer 104, Rx transducer 106, and sample 102. Furthermore, various attachment or fixturing mechanisms (e.g., pneumatic, compression, screws, etc.) can also be used for establishing or enhancing the contact between Tx transducer 104, Rx transducer 106, and sample 102.

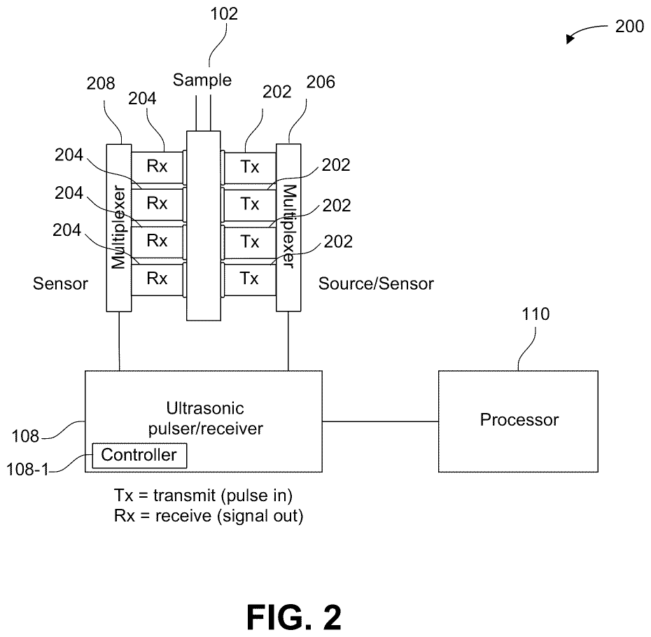

FIG. 2 illustrates another example system for analyzing a sample using acoustic signal-based analysis according to some aspects of the present disclosure. In comparison with FIG. 1, system 200 of FIG. 2 illustrates a system in which multiple pairs of transmitting and receiving transducers are used for transmitting signals through a sample under testing (e.g., a battery cell) and performing acoustic signal-based analysis of the sample.

System 200 includes several transmitting Tx transducers 202 (each of which may be the same as Tx transducer 104 of FIG. 1). While an array of four examples Tx transducers 202 are shown in FIG. 2, the disclosure is not limited to four. Any number of transducers may be used (e.g., any number of Tx transducers ranging from 1 to 10, 15, 20, etc.).

Similarly, system 200 includes a number of receiving (sensing) Rx transducers 204 (each of which may be the same as Rx transducer 106 of FIG. 1). While an array of four examples Rx transducers 204 are shown in FIG. 2, the disclosure is not limited to four. Any number of transducers may be used (e.g., any number of Rx transducers ranging from 1 to 10, 15, 20, etc.). Any given one of Tx transducers 202 may form a transducer pair with one of Rx transducers 204 (FIG. 2 illustrates four transducer pairs). FIG. 2 also illustrates a multiplexer 206 coupled to the array of four Tx transducers 202 and a multiplexer 208 coupled to the array of four Rx transducers 204. As described above, each one of multiplexers 206 and 208 may be configured in communication with the acoustic pulser/receiver 108 for separating and channeling the excitation signals to be transmitted and the response signals received, respectively. In some examples, various acoustic couplants can be used (e.g., solid, liquid, or combinations thereof) for making or enhancing contact between Tx transducers 202 and Rx transducers 204 and sample 102. Furthermore, various attachment or fixturing mechanisms (e.g., pneumatic, compression, screws, etc.) can also be used for establishing or enhancing the contact between Tx transducers 202 and Rx transducers 204 and sample 102.

Spacing between Tx transducers 202 and Rx transducers 204 may be uniform and the same. System 200 also includes additional elements such as sample 102, ultrasonic pulser/receiver 108 (controller 108-1), processors 110, each of which may be the same as the corresponding counterpart described above with reference to FIG. 1 and hence will not be described further for sake of brevity.

During the formation stage, a battery cell undergoes a number of charge/discharge cycles (e.g., anywhere between 1 to 10 but can be more than 10). SEI is a passivation layer that forms between the electrode of a given battery cell such as battery cell (sample) 102 and a solvent such as electrolytes. SEI may be formed of a densely packed inorganic layer covered by loosely packed organic layers of organic material. If no SEI is formed, during any charge/discharge cycle, Lithium-Ion particles pass between the electrode and the electrolyte and cause the electrolyte to breakdown until the battery cell is dead. Hence, homogeneity and uniformity of SEI formation across a battery cell is important to quality of longevity of the battery cell during use.

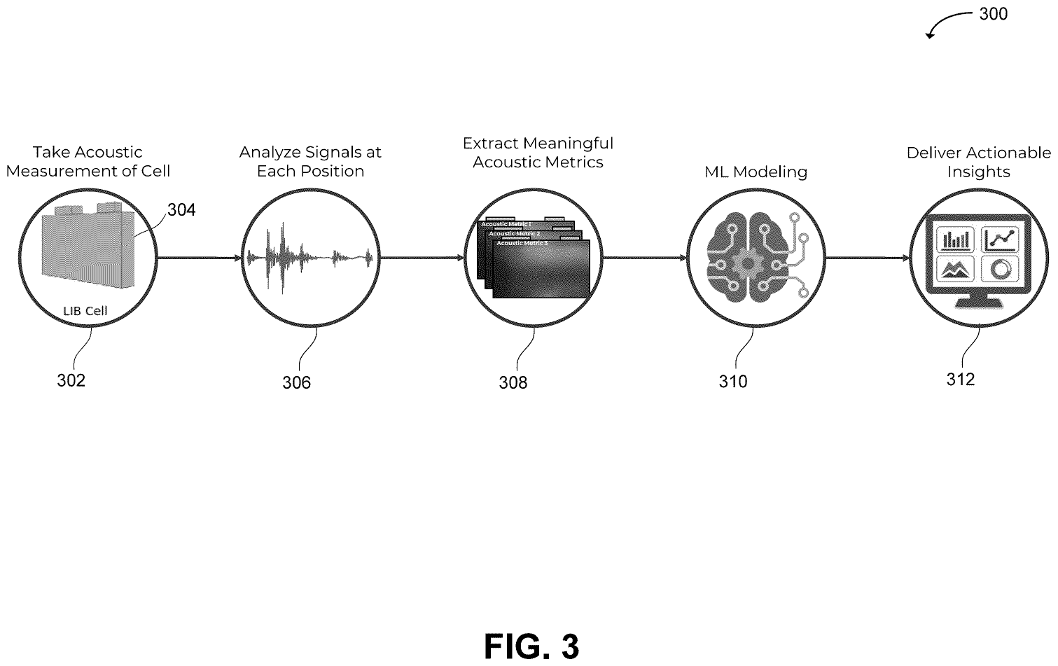

FIG. 3 illustrates an example process flow for determining a quality of SEI formation of a battery cell according to some aspects of the present disclosure.

As noted above, manufacturing process of a battery cell typically includes a number of stages such as wetting, formation, aging, etc. Completion of the aging process may be referred to as the end of the production line. These processes and the end of production may be referenced in describing FIG. 3.

Example process 300 of FIG. 3 has several stages. The first stage may be stage 302 where a battery cell 304 may undergo acoustic measurements. Battery cell 304 maybe a Lithium-Ion Battery (LIB) cell and may be the same as sample 102 described above with reference to FIGS. 1 and 2. The acoustic measurements may be taken using example systems described above with reference to FIGS. 1 and 2. Battery cell 304 may be at the end of the production line or may have completed any of the intermediary stages of the production such as wetting, formation, aging, etc.

Stage 306 of process 300 may involve analyzing acoustic signals transmitted through each point of battery cell 304 and received there though. Any known or to be developed signal pre-processing and analysis methodologies may be applied at this stage.

Based on the results of the signal analysis performed, at stage 308, meaningful acoustic metrics indicative of physical characteristics of battery cell 304 may be obtained (e.g., after pre-processing the received signals). Such physical characteristics include, but are not limited to, quality of SEI formation, which will be further described below.

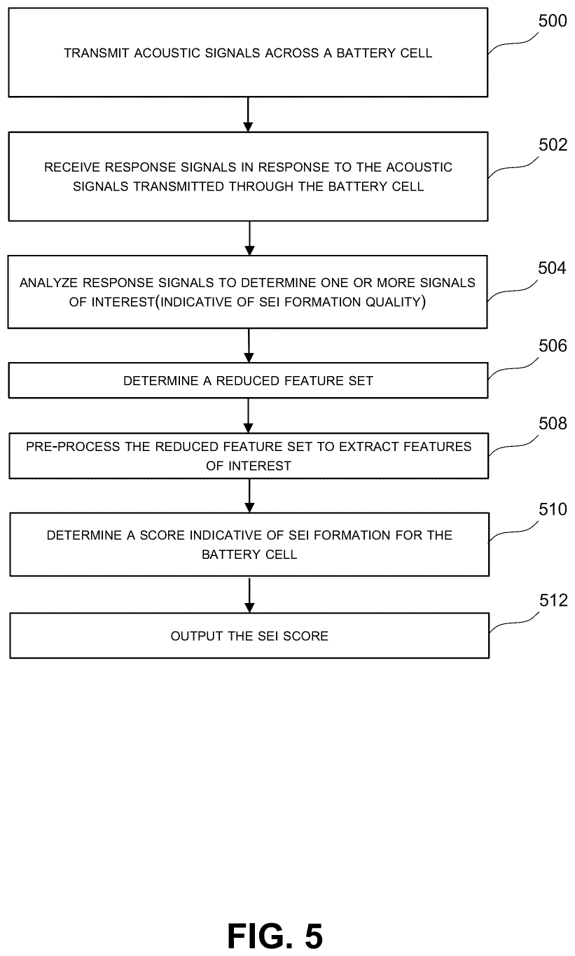

At stage 310, meaningful acoustic metrics indicative of SEI formation may be analyzed and an SEI formation score may be generated. In some examples, a trained machine learning model may be utilized for predicting/assessing quality and durability of battery cell 304 given a particular SEI score. This will be further described below with reference to FIGS. 5-7.

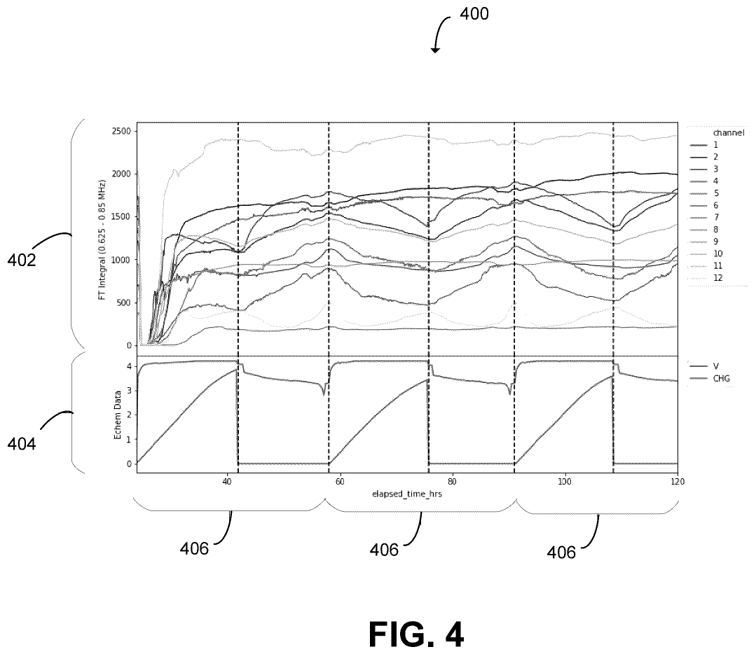

In one example, the output of stage 310 and/or the SEI score may be provided as an actionable insight output at stage 312. Such output may be an actionable insight because it can allow a battery manufacturer to assess the quality of SEI formation for a given battery cell, the implemented formation process(es) during manufacturing, etc. FIG. 4 is an example illustration of acoustic signals captured during a formation process of a battery cell for purposes of determining an SEI formation score according to some aspects of the present disclosure.

Visual output 400 of FIG. 4 includes two graphs, namely graph 402 and graph 404. Graph 402 shows acoustic signals received, after transmission through battery cell 304. Graph 402 shows multiple outputs each corresponding to a different channel. Each channel may correspond to a location on battery cell 304 through which an acoustic signal is transmitted and received. Graph 402 shows a non-limiting example of 12 channels. Graph 402 shows the Fourier Transform (FT) integral of received acoustic signals plotted against time elapsed (e.g., in hours) during the formation process where battery cell 304 goes through multiple charge/discharge cycles.

Graph 404 shows voltage and charge applied to battery cell 304 during three example charge-discharge cycles 406. Each charge-discharge cycle 406 starts with charging of battery cell 304 (hence the ramp up in voltage and charge shown in graph 404) followed by a discharge (hence the drop in voltage and charge shown in graph 404).

Graph 402 shows that the FT output of each channel follows (breathes) the same pattern as the charge-discharge cycle.

As will be described below, a score may be assigned to each output shown in graph 402 (e.g., between 0 to 1 with 0 indicating no SEI formed at that particular measurement location and 1 indicating complete SEI formed at that particular location). In some examples too thick of an SEI layer can be as bad as no SEI formed and can be indicative of a sub-optimal formation process used during the manufacturing of battery cell 304. In other words, a score of ‘1’ may be as bad as a score ‘0’. Therefore, it may be the case that over time a score between 0.4 to 0.6 may be associated with a “good” SEI formation for a given battery cell.

In one example, an average (e.g., a simple average, a weighted average, etc.) may be used to combine the SEI score of all channels to determine a comprehensive SEI score for battery cell 304).

FIG. 5 illustrates an example method of determining an SEI score for a battery cell according to some aspects of the present disclosure. The process of FIG. 5 will be described from the perspective of processor 110 (a controller). However, the present disclosure is not limited to implementation of steps of FIG. 5 by processor 110 and instead the example steps of FIG. 5 can be performed by more than one processor and/or any other controller associated with system 100 and/or system 200.

At step 500, a controller may send one or more commands to one or more transmitters (e.g., a first subset of transducers such as Tx transducer 104 and/or Tx transducers 202) for transmitting acoustic signals through a battery cell such as battery cell 304, sample 102, etc.

In some examples, battery cell 304 through which the acoustic signals are transmitted is progressing through and/or has completed a formation stage of battery manufacturing process.

At step 502, the controller may receive response signals in response to the acoustic signals transmitted through the battery cell. The response signals may be received from one or more receiving transducers (a second subset of transducers) such as Rx transducer 106 and/or Rx transducers 204.

In some example embodiments, transmission of the one or more commands at step 500 may be automatically triggered upon detection of an event such as placement of battery cell 304 at a designated position in between transmitting and receiving transducers such as Tx transducer/Rx transducer 106 and/or Tx transducers 202/Rx transducers 204.

Steps 500 and 502 may correspond to stage 302 of FIG. 3.

At step 504, the controller may analyze the received response signals to identify one or more signals of interest (e.g., one or more signals indicative of SEI formation quality).

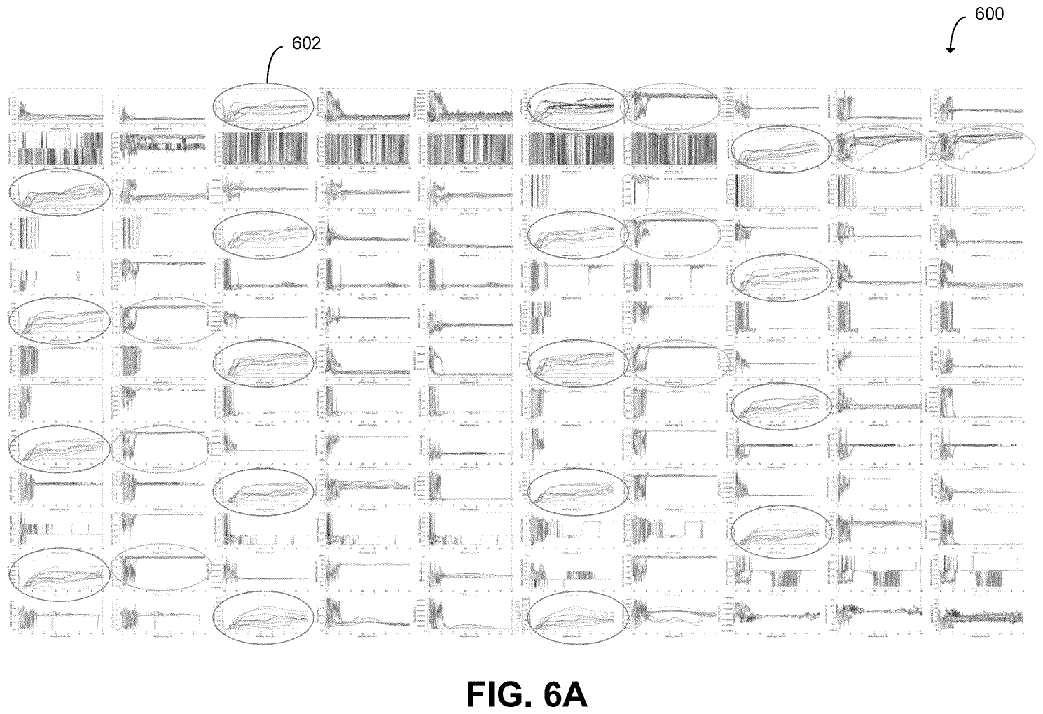

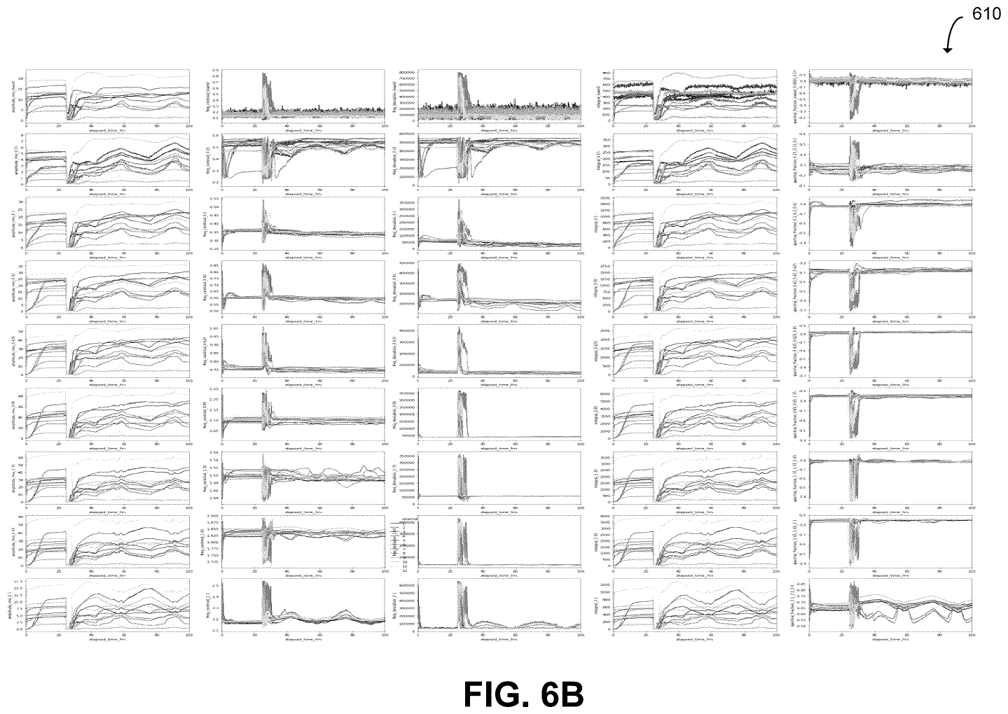

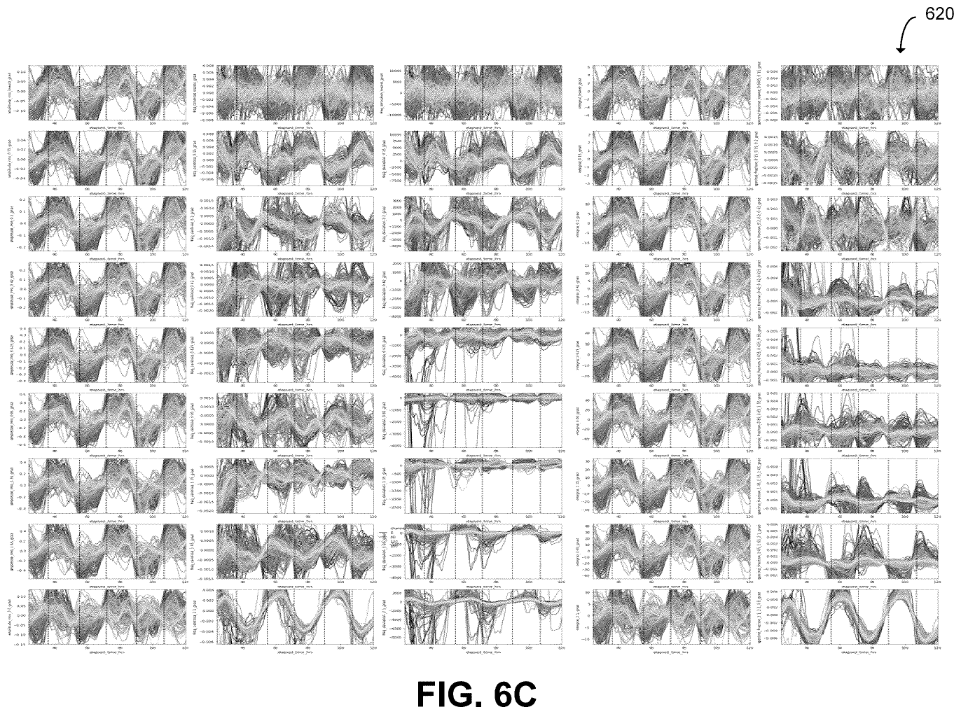

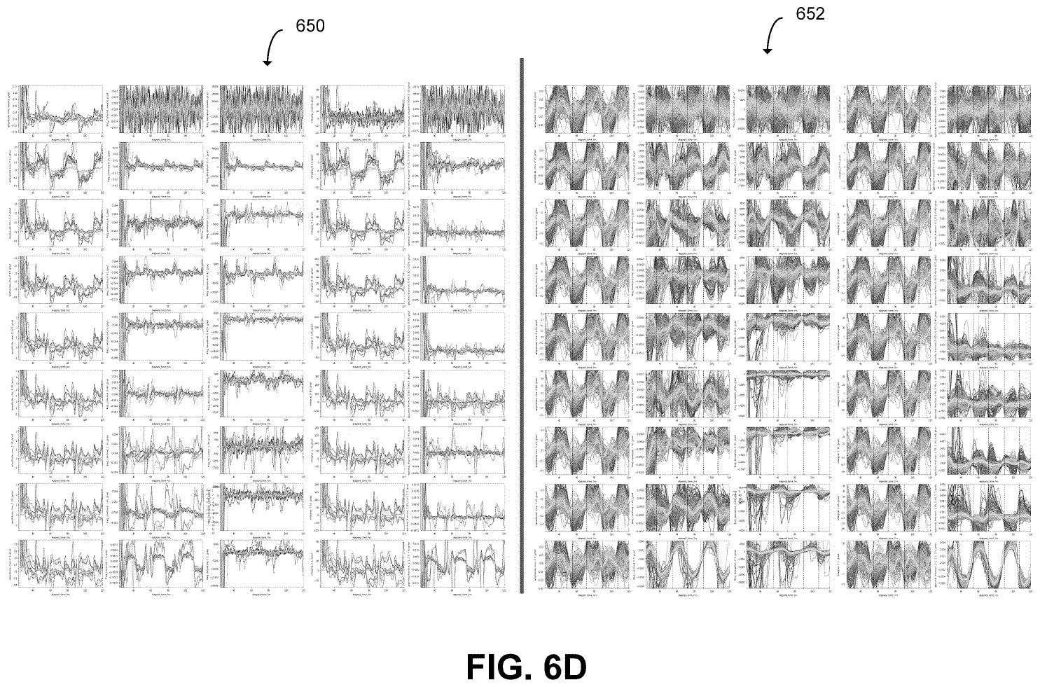

FIGS. 6A-D illustrate various examples of acoustic signals output as they are processed for determining an SEI formation score for a battery cell according to some aspects of the present disclosure. FIGS. 6A-D are referred to with reference to one or more steps of FIG. 5.

FIG. 6A shows an example of various received response signals, each of which may represent a different physical phenomenon associated with the structure of battery cell 304 (e.g., wetting quality, present of physical defects, SEI formation, etc.). Output 600 may be referred to as feature set 600.

In one example, the controller may analyze all the received response signals to determine which one(s) correspond to the phenomenon of SEI formation. As noted with respect to FIG. 4, an output signal may be indicative of SEI formation, if such output follows/breathes the charge/discharge cycles. In the non-limiting example of FIG. 6A, circled outputs such as output 602 can be identified as signals indicative of SEI formation as they fluctuate in a similar manner as a charge-discharge cycle such as that shown in graph 402 of FIG. 4.

The process of identifying outputs of interest may be manual. In another example, the process may be automated so that the controller can identify outputs of interest. For example, processor 110 may be programmed to identify outputs having a particular pattern (e.g., sinusoidal pattern, multiple max/mins with the greatest initial max/min difference, etc.). In some examples, a trained (e.g., a supervised) machine learning model may be utilized, which can take as input received acoustic response signals and identify signals of interest (e.g., output signals associated with SEI formation).

At step 506 and based on the analysis of step 504, the controller may output a reduced feature set (i.e., reduced output signals) corresponding to the feature of interest, which in this non-limiting example is SEI formation. FIG. 6B shows an example of reduced feature set 610 formed of outputs such as output 602 from among outputs of feature set 600 of FIG. 6A.

At step 508, the controller may pre-process the reduced feature set to extract meaningful features indicative of quality of SEI formation. In one example, such pre-processing may include determining a rate of change of each output in reduced feature set 610. FIG. 6C illustrates one example of a feature set 620 that includes a corresponding rate of change of each output in reduced feature set 610. Pre-processing in this context is not limited to determining a rate of change and may include any other signal processing method that can extract meaningful information/features from the signals indicative of SEI formation quality.

In another example, the pre-processing may include embedding to reduce dimensionality of reduced feature set 610 (e.g., from 45 outputs to 1). Non-limiting examples of embedding techniques that can be used include, but are not limited to, principal component analysis, non-linear manifold learning, etc.

In one example, steps 504, 506, and 508 may correspond to stages 306 and 308 of FIG. 3.

At step 510, the controller may determine a score indicative of SEI formation of the battery cell, in part based on the features (e.g., rate of change) extracted at step 508.

In one example, each output and the associated rate of change may be assigned a score and thus an overall score for battery cell 304 may be determined as an average (e.g., a simple average, a weighted average, etc.) of the score for each channel/output in reduced feature set 610.

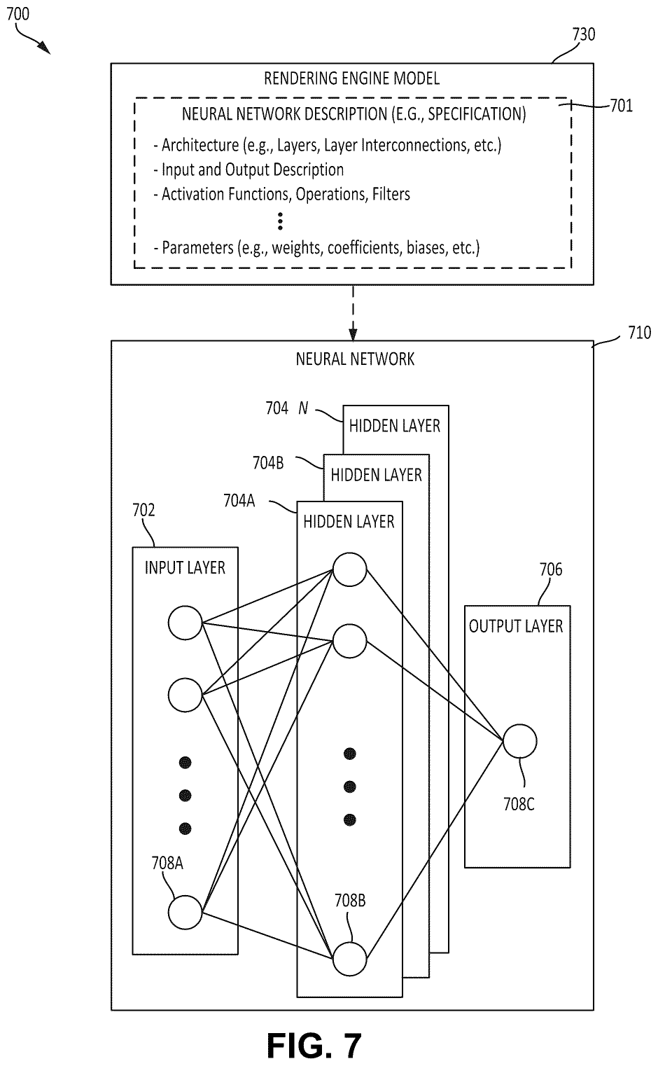

In one example, a trained machine learning model, which will be described below with reference to FIG. 7 may be utilized to determine the score at step 510. Such trained model may take as input the feature set 620 of FIG. 6C and produce, as output, an overall SEI formation score for battery cell 304. In another example, the input may be the reduced feature set 610 of FIG. 6B.

In another example, the input can be the received acoustic signals (e.g., feature set 600 of FIG. 6A), where the trained machine learning model identifies outputs of interest (step 504) and based thereon determines the SEI formation per steps 506-510.

In one example and as such machine learning model is trained and updated, various feature sets (and/or reduced or pre-processed feature sets) can be correlated with “good” SEI formations. A “good” SEI formation may be identified in correlation with performance of battery cells and hence a score indicative of a desirable SEI formation may be associated therewith (e.g., in the range of 0.4-0.6, etc.). Once a bank of “good” SEI formations is generated, the trained machine learning model can analyze a given output (or a pre-processed version thereof showing, for example, a rate of change) and perform a comparison with outputs of “good” SEI formations to determine an SEI formation score for the given output.

FIG. 6D illustrates a comparison of feature set 620 (rate of change) for a “bad” battery cell (shown as feature set 650) and “good” battery cell (shown as feature set 652). As can be seen from FIG. 6D, there is a noticeable difference/variation among the rate of change of different outputs for a “bad” battery cell in feature set 650, whereas there is more uniformity among the rate of change of outputs shown in feature set 652. The more consistent a reduced feature set is (or the more consistent a rate of change of outputs in a reduced feature set is), the better the battery cell and hence the better would be the ultimate SEI formation score for that battery cell.

At step 512, the SEI score may be presented on a graphical user interface as an actionable insight as described above with reference to stage 312 of FIG. 3. In some examples, a particular manufacturer utilizing a battery inspection system of FIGS. 1 and 2, may have implemented a particular formation process. As battery cells such as battery cell 304 progress through and complete the formation stage, each may be tested acoustically using the battery inspection system of the present disclosure and hence each may be assigned an SEI score. In this instance, any given SEI score may not, in and of itself, be of particular significance or indicative of good or bad SEI formation quality. Instead, the battery manufacturer may look at the SEI scores for a batch of battery cells and determine if there are outlier scores or whether all scores are within a configurable/defined margin of error. If latter, then the battery manufacturer may conclude that the implemented formation process is acceptable/working and battery cells in the batch have, more or less, the same SEI formation quality. Otherwise, any SEI score that is an outlier relative to the other scores for the batch may be indicative of a problematic battery cell, and/or may be indicative of an inconsistent/problematic SEI formation process that should be examined, modified, etc.

Therefore, the SEI formation scores can serve as a basis for flagging “problematic” individual battery cell(s) in a given batch and/or provide an indication as to the particular formation process implemented by the battery manufacturer.

FIG. 7 illustrates an example neural network that can be utilized for predicting future performance of battery cells according to some aspects of the present disclosure.

Architecture 700 includes a neural network 710 defined by an example neural network description 701 in rendering engine model (neural controller) 730. Neural network 710 can be used for determining an SEI formation score for battery cell 304 as described above with reference to FIGS. 3-6A-D. Neural network description 701 can include a full specification of neural network 710. For example, neural network description 701 can include a description or specification of the architecture of neural network 710 (e.g., the layers, layer interconnections, number of nodes in each layer, etc.); an input and output description which indicates how the input and output are formed or processed; an indication of the activation functions in the neural network, the operations or filters in the neural network, etc.; neural network parameters such as weights, biases, etc.; and so forth.

In this example, neural network 710 includes an input layer 702, which can receive input data including, but not limited to, acoustic response signals received at the controller per step 502 of FIG. 5 (e.g., feature set 600 of FIG. 6A), reduced feature set acoustic metrics (e.g., reduced feature set 610 of FIG. 6A, and/or pre-processed version of reduced feature set such as feature set 620 of FIG. 6C, for a given battery cell.

Neural network 710 includes hidden layers 704A through 704N (collectively “504” hereinafter). Hidden layers 704 can include n number of hidden layers, where n is an integer greater than or equal to one. The number of hidden layers can include as many layers as needed for a desired processing outcome and/or rendering intent. Neural network 710 further includes an output layer 706 that provides as output, an SEI formation score for battery cell 304, as described above.

Neural network 710 in this example is a multi-layer neural network of interconnected nodes. Each node can represent a piece of information. Information associated with the nodes is shared among the different layers and each layer retains information as information is processed. In some cases, neural network 710 can include a feed-forward neural network, in which case there are no feedback connections where outputs of the neural network are fed back into itself. In other cases, neural network 710 can include a recurrent neural network, which can have loops that allow information to be carried across nodes while reading in input.

Information can be exchanged between nodes through node-to-node interconnections between the various layers. Nodes of input layer 702 can activate a set of nodes in first hidden layer 704A. For example, as shown, each of the input nodes of input layer 702 is connected to each of the nodes of first hidden layer 704A. The nodes of hidden layer 704A can transform the information of each input node by applying activation functions to the information. The information derived from the transformation can then be passed to and can activate the nodes of the next hidden layer (e.g., 704B), which can perform their own designated functions. Example functions include convolutional, up-sampling, data transformation, pooling, and/or any other suitable functions. The output of the hidden layer (e.g., 704B) can then activate nodes of the next hidden layer (e.g., 704N), and so on. The output of the last hidden layer can activate one or more nodes of output layer 706, at which point an output is provided. In some cases, while nodes (e.g., nodes 708A, 708B, 708C) in neural network 710 are shown as having multiple output lines, a node has a single output and all lines shown as being output from a node represent the same output value.

In some cases, each node or interconnection between nodes can have a weight that is a set of parameters derived from training neural network 710. For example, an interconnection between nodes can represent a piece of information learned about the interconnected nodes. The interconnection can have a numeric weight that can be tuned (e.g., based on a training dataset), allowing neural network 710 to be adaptive to inputs and able to learn as more data is processed.

Neural network 710 can be pre-trained to process the features from the data in the input layer 702 using the different hidden layers 704 in order to provide the output through output layer 706. In this example, neural network 710 can be trained using training data that includes prior feature sets representing various SEI formations, their correlation with battery performance (e.g., post-production battery performance) and associated SEI scores, as described above.

In one or more examples, training of neural network 710 may be supervised, whereby the model is trained using labeled datasets whereby one or more aspects of neural network 710, such as weights, biases, etc., are tuned until neural network 710 returns the expected result for a given type of battery cell. In other examples, the training may be unsupervised.

In some examples, the training may be based on zero-shot learning and/or transfer learning.

In some cases, neural network 710 can adjust weights of nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training media data until the weights of the layers are accurately tuned.

For a first training iteration for neural network 710, the output can include values that do not give preference to any particular class due to the weights being randomly selected at initialization. For example, if the output is a vector with probabilities that the object includes different product(s) and/or different users, the probability value for each of the different product and/or user may be equal or at least very similar (e.g., for ten possible products or users, each class may have a probability value of 0.1). With the initial weights, neural network 710 is unable to determine low level features and thus cannot make an accurate determination of what the classification of the object might be. A loss function can be used to analyze errors in the output. Any suitable loss function definition can be used.

The loss (or error) can be high for the first training dataset (e.g., images) since the actual values will be different than the predicted output. The goal of training is to minimize the amount of loss so that the predicted output comports with a target or ideal output. Neural network 710 can perform a backward pass by determining which inputs (weights) most contributed to the loss of neural network 710 and can adjust the weights so that the loss decreases and is eventually minimized.

A derivative of the loss with respect to the weights can be computed to determine the weights that contributed most to the loss of neural network 710. After the derivative is computed, a weight update can be performed by updating the weights of the filters. For example, the weights can be updated so that they change in the opposite direction of the gradient. A learning rate can be set to any suitable value, with a high learning rate including larger weight updates and a lower value indicating smaller weight updates.

Neural network 710 can include any suitable neural or deep learning network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. In other examples, neural network 710 can represent any other neural or deep learning network, such as an autoencoder, a deep belief networks (DBN), a recurrent neural network (RNN), etc.

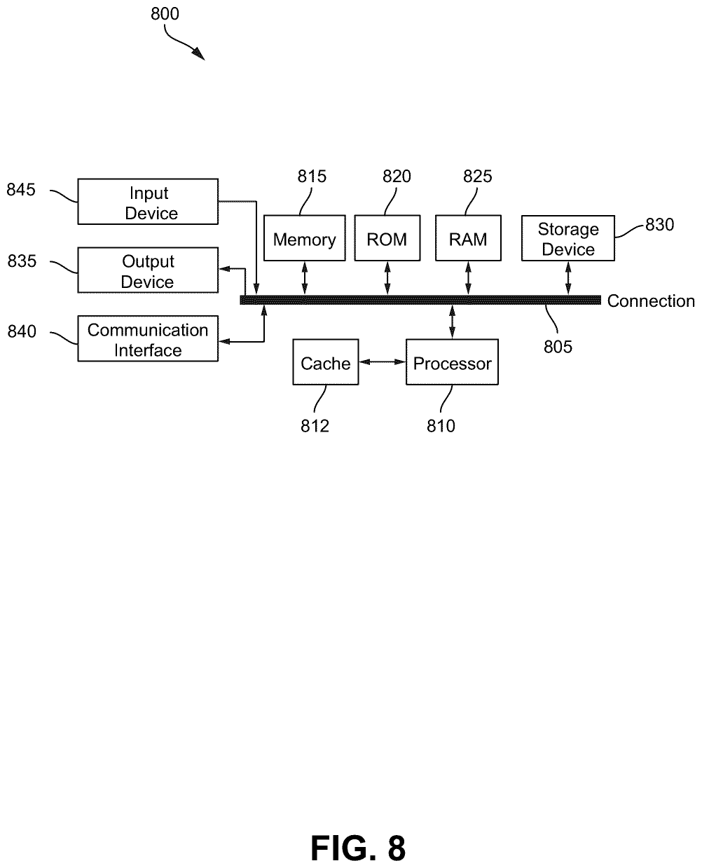

FIG. 8 illustrates an example architecture of a computing device according to some aspects of the disclosure. Computing device architecture 800 of an example computing device can be used as various components of system 100 or 200 (e.g., processor 110) to implement various techniques described herein. The components of the computing device architecture 800 are shown in electrical communication with each other using a connection 805, such as a bus. The example computing device architecture 800 includes a processing unit (e.g., a CPU such as processor 810) and a connection 805 that couples various computing device components including the computing device memory 815, such as read only memory (ROM) 820 and random access memory (RAM) 825, to the processor 810.

The computing device architecture 800 can include a cache of high-speed memory connected directly with, in close proximity to, or integrated as part of the processor 810. The computing device architecture 800 can copy data from the computing device memory 815 and/or the storage device 830 to the cache 812 for quick access by the processor 810. In this way, the cache can provide a performance boost that avoids processor 810 delays while waiting for data. These and other modules can control or be configured to control the processor 810 to perform various actions. Other computing device memory 815 may be available for use as well. The computing device memory 815 can include multiple different types of memory with different performance characteristics. The processor 810 can include any general-purpose processor and a hardware or software service stored in storage device 830 and configured to control the processor 810 as well as a special-purpose processor where software instructions are incorporated into the processor design. The processor 810 may be a self-contained system, containing multiple cores or processors, a bus, memory controller, cache, etc. A multi-core processor may be symmetric or asymmetric.

To enable user interaction with the computing device architecture 800, an input device 845 can represent any number of input mechanisms, such as a microphone for speech, a touch-sensitive screen for gesture or graphical input, keyboard, mouse, motion input, speech and so forth. An output device 835 can also be one or more of a number of output mechanisms known to those of skill in the art, such as a display, projector, television, speaker device. In some instances, multimodal computing devices can enable a user to provide multiple types of input to communicate with the computing device architecture 800. The communication interface 840 can generally govern and manage the user input and computing device output. There is no restriction on operating on any particular hardware arrangement and therefore the basic features here may easily be substituted for improved hardware or firmware arrangements as they are developed.

Storage device 830 is a non-volatile memory and can be a hard disk or other types of computer readable media which can store data that are accessible by a computer, such as magnetic cassettes, flash memory cards, solid state memory devices, digital versatile disks, cartridges, random access memories (e.g., RAM 825), read only memory (e.g., ROM 820), and hybrids thereof. The storage device 830 can include software, code, firmware, etc., for controlling the processor 810. Other hardware or software modules are contemplated. The storage device 830 can be connected to the connection 805. In one aspect, a hardware module that performs a particular function can include the software component stored in a computer-readable medium in connection with the necessary hardware components, such as the processor 810, connection 805, output device 835, and so forth, to carry out the function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per sc.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

While the foregoing disclosure shows illustrative aspects of the invention, it should be noted that various changes and modifications could be made herein without departing from the scope of the invention as defined by the appended claims. The functions, steps and/or actions of the method claims in accordance with the aspects of the invention described herein need not be performed in any particular order. Furthermore, although elements of the invention may be described or claimed in the singular, the plural is contemplated unless limitation to the singular is explicitly stated.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A method comprising:
transmitting acoustic signals through a battery cell via one or more first transducers;
receiving response signals in response to the acoustic signals at one or more second transducers;
determining a score indicative of quality of Solid Electrolyte Interphase (SEI) formation in the battery cell based on analyzing the response signals; and
outputting the score.

2. The method of claim 1, wherein determining the score comprises:
pre-processing the response signals to determine a rate of change of the SEI formation across the battery cell; and
determining the score based at least on the rate of change.

3. The method of claim 2, wherein pre-processing the response signals comprises:
selecting a subset of the response signals representing acoustic features corresponding to the SEI formation;
determining the rate of change in each of the subset of the response signals; and
performing an embedding process to determine the score.

4. The method of claim 3, wherein the embedding process is one of a principal component analysis or a non-linear embedding process.

5. The method of claim 1, wherein the score is determined using a trained machine learning model.

6. The method of claim 5, wherein the trained machine learning model receives, as input, a subset of the response signals representing acoustic features corresponding to the SEI formation, and provides, as output, the score.

7. The method of claim 1, wherein the battery cell is going through a manufacturing process when the acoustic signals are transmitted therethrough.

8. The method of claim 1, wherein the score is outputted on a graphical user interface.

9. The method of claim 1, wherein the score is a weighted average of a plurality of scores, each of the plurality of scores corresponding to a different location on the battery cell through which one of the acoustic signals is transmitted.

10. A battery inspection system, comprising:
a plurality of transducers; and
a controller communicatively coupled to the plurality of transducers, the controller being configured to:
send one or more commands to a first subset of the plurality of transducers for transmitting acoustic signals through a battery cell;
receive, from a second subset of the plurality of transducers, response signals in response to the acoustic signals transmitted through the battery cell;
determine a score indicative of quality of Solid Electrolyte Interphase (SEI) formation in the battery cell based on analyzing the response signals; and
output the score.

11. The battery inspection system of claim 10, wherein the controller is further configured to determine the score by:
pre-processing the response signals to determine a rate of change of the SEI formation across the battery cell; and
determining the score based at least on the rate of change.

12. The battery inspection system of claim 11, wherein the controller is further configured to pre-process the response signals by:
selecting a subset of the response signals representing acoustic features corresponding to the SEI formation;
determining the rate of change in each of the subset of the response signals; and
performing an embedding process to determine the score.

13. The battery inspection system of claim 12, wherein the embedding process is one of a principal component analysis or a non-linear embedding process.

14. The battery inspection system of claim 10, wherein the score is determined using a trained machine learning model.

15. The battery inspection system of claim 14, wherein the trained machine learning model receives, as input, a subset of the response signals representing acoustic features corresponding to the SEI formation, and provides, as output, the score.

16. The battery inspection system of claim 10, wherein the battery cell is going through a manufacturing process when the acoustic signals are transmitted therethrough.

17. The battery inspection system of claim 10, wherein the score is outputted on a graphical user interface.

18. The battery inspection system of claim 10, wherein the score is a weighted average of a plurality of scores, each of the plurality of scores corresponding to a different location on the battery cell through which one of the acoustic signals is transmitted.

19. One or more non-transitory computer-readable media comprising computer-readable instructions, which when executed by one or more processors of a battery inspection system, cause the battery inspection system to:
send one or more commands to a first subset of a plurality of transducers for transmitting acoustic signals through a battery cell;
receive, from a second subset of the plurality of transducers, response signals in response to the acoustic signals transmitted through the battery cell;
determine a score indicative of quality of Solid Electrolyte Interphase (SEI) formation in the battery cell based on analyzing the response signals; and
output the score.

20. The one or more non-transitory computer-readable media of claim 19, wherein the score is determined using a trained machine learning model.
